(19) United States
(12) Patent Application Publication
(10) Pub. No.: US 2005/0131128 A1
(43) Pub. Date: Jun. 16, 2005

(54) Surface repair composites and methods

(76) Inventors: Anthony M. Hughes, Norcross, GA (US); Richard S. Bullens, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/736,321

(22) Filed: Dec. 15, 2003

(51) Int. Cl. B32B 35/00; C08K 3/40; C08K 3/34

(52) U.S. Cl. 524/494; 427/140; 524/492; 524/442

(57) ABSTRACT

Surface repair composites and methods of use and manufacture are disclosed. In one embodiment, a surface repair composite includes a resin, a catalyst, an aggregate, and a fiber mixed with the resin, the catalyst, and the aggregate.

### TECHNICAL FIELD

The present invention is generally related to surface repair and, more particularly, is related to concrete and asphalt repair composites and methods.

### DESCRIPTION OF THE RELATED ART

Concrete and asphalt are composite materials that are commonly used in the construction of buildings and infrastructures throughout the world. Typically, such composite materials are used for highways, bridges, driveways, sidewalks, parking decks, among other applications. Over time, such composite materials can deteriorate, leading to cracks, spalls, and/or other surface irregularities that often result in a need for repairs.

Current asphalt or concrete repair products are typically provided as a composite material (e.g., having a mixture of one or more materials that forms a cohesive material although including one or more insoluble constituents) that attempts to bond to or merge with irregular surfaces (e.g., holes, cracks, etc.) to form a contiguous, often substantially even or flat surface. Such products often require extensive preparation and/or cure time. Further, although a considerable investment in time and resources is often expended, such repair endeavors frequently result in a structure that is weaker (e.g., lower tensile strength) than the original structure, thus providing a short-term solution that requires repeated endeavors.

### SUMMARY

Surface repair composites and methods are provided. Briefly described, one embodiment, among others, of a surface repair composite includes a resin, a catalyst, an aggregate, and a fiber mixed with the resin, the catalyst, and the aggregate.

An embodiment for making a surface repair composite, among others, can be broadly summarized by the following steps: providing a resin, a catalyst, an aggregate, and a fiber; and mixing the resin, the catalyst, the aggregate, and the fiber.

Another embodiment of a method can be broadly summarized by the following steps: providing a surface repair composite, the surface repair composite including a resin, a catalyst, an aggregate, and a fiber; and applying the surface repair composite to a surface.

Other systems, methods, features and/or advantages will be or may become apparent to one with skill in the art upon examination of the following drawings and detailed description. It is intended that all such additional systems, methods, features, and advantages be included within this description.

### BRIEF DESCRIPTION OF THE DRAWINGS

The components in the drawings are not necessarily to scale. Moreover, in the drawings, like reference numerals designate corresponding parts throughout the several views.

FIG. 1 is a flow diagram that illustrates an embodiment of one example method for making a surface repair composite.

FIG. 2 is a flow diagram that illustrates an embodiment of one example method for using a surface repair composite.

FIGS. 3A-3H are schematic diagrams that illustrate the method shown in the flow diagram of FIG. 2.

### DETAILED DESCRIPTION OF THE PREFERRED EMBODIMENTS

Preferred embodiments of a surface repair composites and methods of making and using the same are disclosed. Although described in the context of the repair of concrete, the surface repair composites and methods thereof can be used for the bonding, the repairing and/or the restoring of other materials, such as asphalt, wood, metal, among other materials. For example, the same embodiment of a surface repair composite used for a concrete application can be used in an asphalt application if color matching of the repair surface to the non-repaired asphalt surface is not desired. If color matching is desired (e.g., black repair surface to match the balance of the black surface), then variations in the aggregate can be used, such as using a black slag aggregate as one example.

Embodiments of a surface repair composite may also be used for applications that may not necessarily include repair, such as for bonding applications (e.g., bonding to surfaces to enhance connectivity or otherwise join a surface to other surfaces, etc.).

Embodiments of a surface repair composite can be used as, among other uses, filler material, a topcoat, or as a concrete sealer, thus providing repair and/or restoration of concrete. In addition, embodiments of a surface repair composite can be used to repair asphalt deterioration, such as potholes, seams, and/or other broken or delaminated surfaces. Embodiments of a surface repair composite can address deficiencies in strength of conventional surface repair composites by including a fiber in the composite, such as chopped strand fiberglass, fiber mesh, among other fibrous materials. The fiber can be embodied in a variety of lengths (e.g., ¼″, 1/16″, etc.) and configurations (e.g., flat, cylindrical, etc.). The addition of fiber provides for increased tensile strength, which results in an improved surface robustness for handling heavy loads or significant surface deflections, such as high-traffic areas for heavy equipment, parking decks, among others.

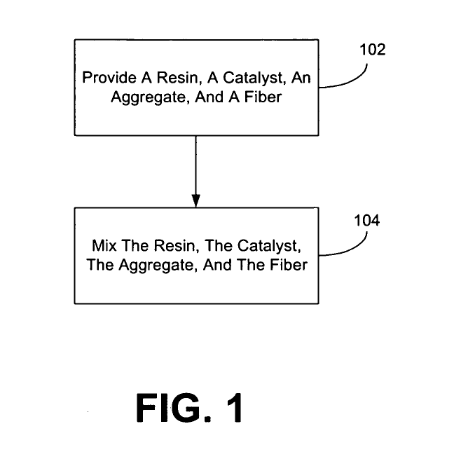

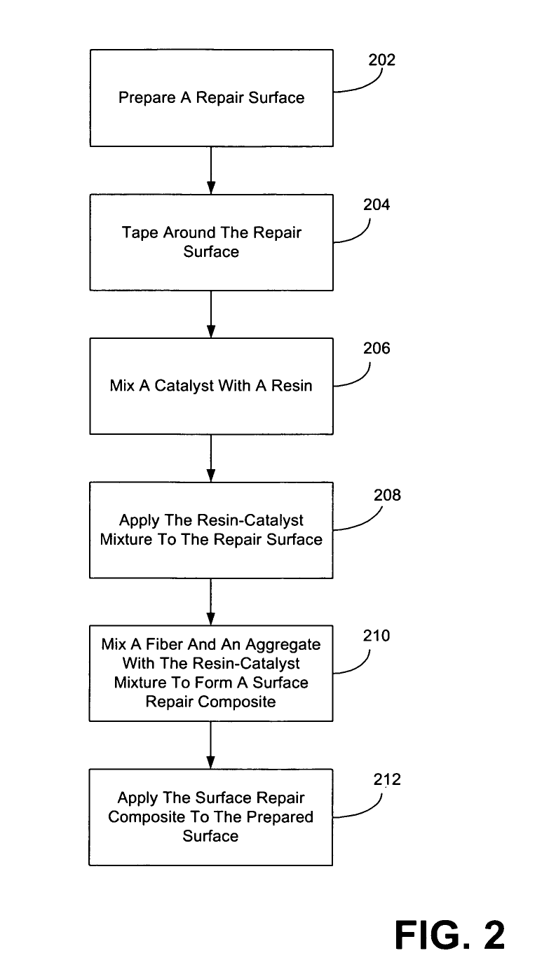

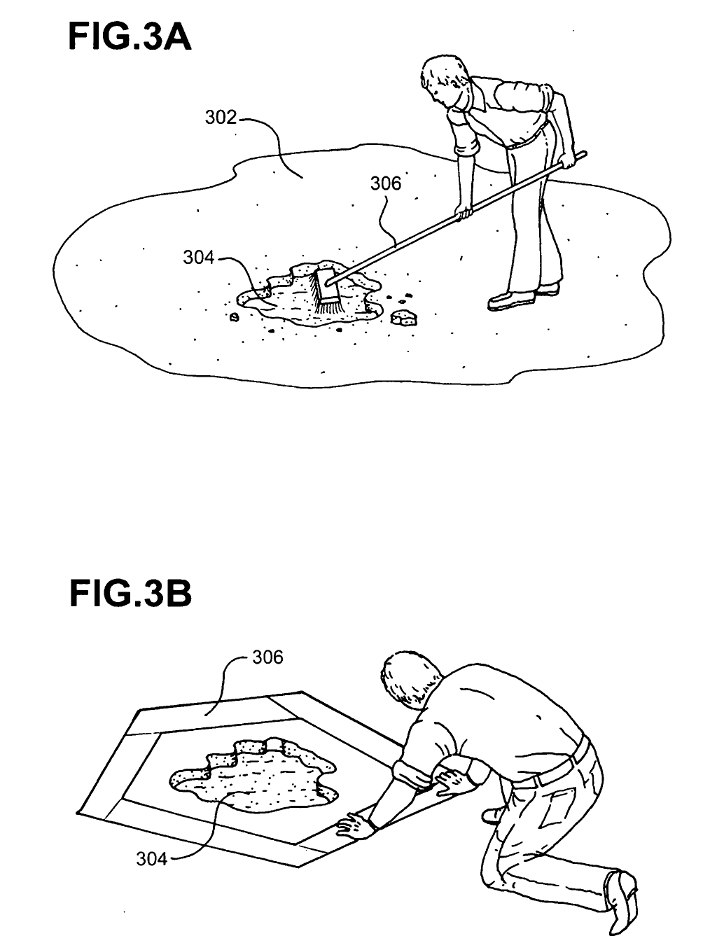

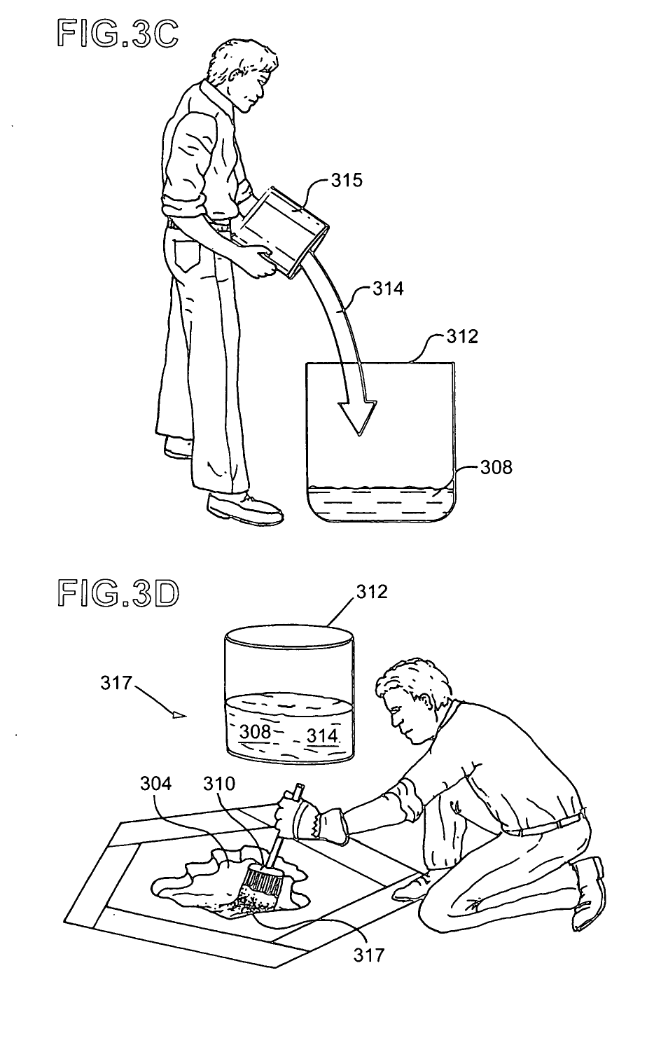

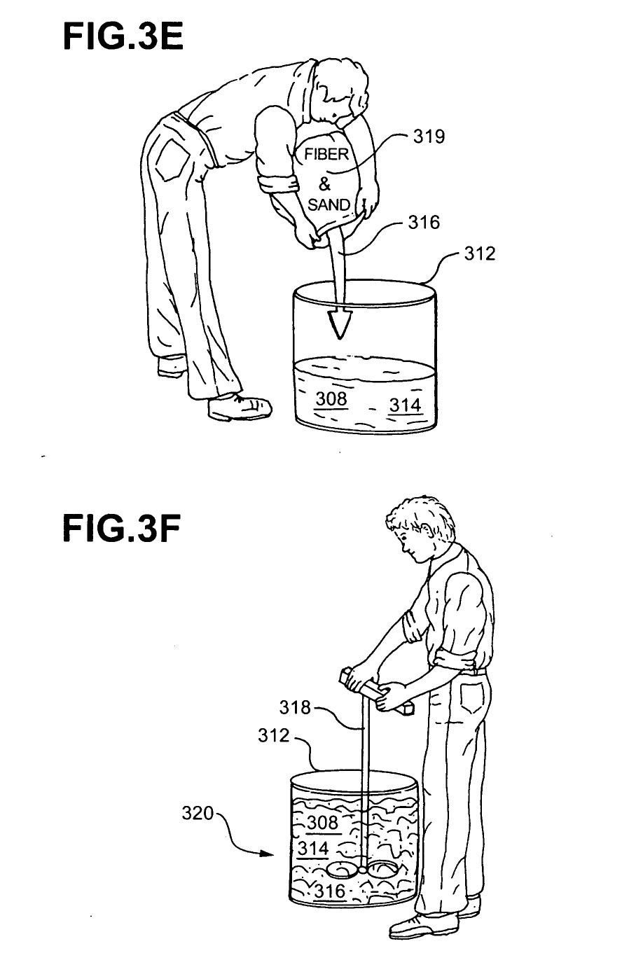

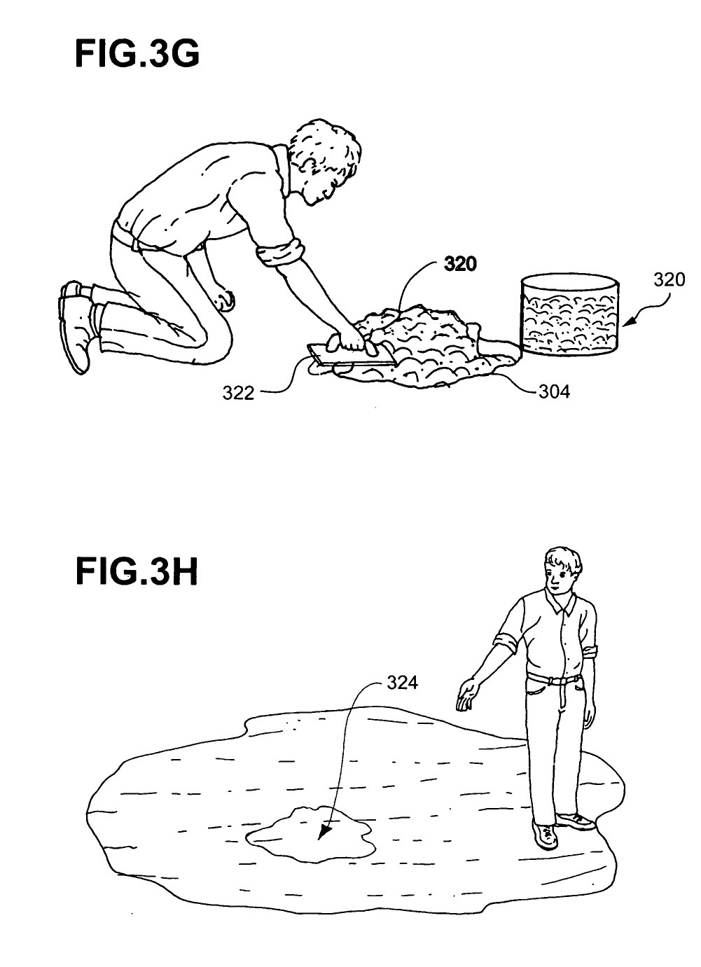

An example method for making an embodiment of a surface repair composite as well as an example method for using a surface repair composite is illustrated in FIGS. 1 and 2. The schematic diagrams in FIGS. 3A-3H are used to further illustrate the corresponding methodology described in FIG. 2.

Any process descriptions or blocks in flow charts should be understood as representing steps in a process. Alternate implementations are included within the scope of the preferred embodiments of the present invention in which steps may be executed out of order from that shown or discussed, including substantially concurrently or in reverse order, depending on the functionality involved, or steps can be omitted or added to the steps shown, as would be understood in the context of the disclosure by those reasonably skilled in the art of the present invention.

FIG. 1 is a flow diagram that illustrates an embodiment of one example method for making a surface repair composite to be used as a surface patch. As shown, step 102 includes providing a resin, a catalyst, an aggregate, and a fiber. The resin is preferably a polyester resin. In some embodiments, the polyester resin can have the performance characteristics illustrated in Table 1 below. These performance characteristics are derived for a composition comprising a polyester resin and an organic catalyst (methyl ethyl ketone peroxide (MEKP)). The performance characteristics are approximate and used for example only, with the understanding that other resins and catalysts of different characteristics can be used.

TABLE 1

| Liquid Resin Characteristics | @ 77 deg F. |
|---|---|
| Gel time | 22 minutes |
| Gel time to peak exotherm | 45 minutes |
| Peak exothermic temperature | 287 deg F. |
| Viscosity | 400-600 |
| Percent NVM (non-volatile materials) | 67 |
| Specific gravity | 1.13 |
| Cured Resin Properties | |
| Heat distortion (ASTM-D6-48-56) | 110 deg F. |
| Compressive Strength (with aggregate) | 6,800 psi (10 days) |
| Tensile strength (ASTM-D-638-68) | 7,300 psi |
| Tensile elongation (ASTM-638) | 40% |
| Tensile modulus, psi × 10\hat{ }5^{th} (ASTM- | 1.38 |
| D638) | |
| Flexural strength, psi (ASTM-D790) | 1,500 psi |
| Flexural modulus, psi × 10\hat{ }5 (ASTM- | 3.73 |
| 790) | |
| Bond strength | Exceeds (ASTM-C1059-86) |
| | Type II |
| Physical properties | |
| boiling point | 293.40 deg F. |
| flash point | 89 deg F. |
| vapor pressure (Max) | 5.00 MM HG@20 C. |
| Evaporation rate (SATER = 1) | 1 |
| Vapor density (AIR = 1) | 3.8 |

As indicated above, other resins can be used, including epoxy-based and vinyl esters.

The catalyst, or activator, is preferably an organic peroxide, such as MEKP, benzoyl peroxide (BPO), among others. The amount of catalyst to mix with the resin depends at least on the ambient temperature and the surface area subject to repair and/or restoration, and thus on the amount of resin. Generally, the higher the ambient temperature, the lower the amount of catalyst to use with the resin. For example, assume a polyester resin and catalyst mix that exhibits the characteristics shown in Table 1. For a gallon of polyester resin to be used at an ambient temperature of less than 70 degrees, approximately 60 cubic centimeters of organic catalyst such as MEKP is recommended. For the same amount of polyester resin for use at ambient temperatures above 85 degrees, approximately 40 cubic centimeters of organic catalyst is recommended. As another example, for smaller patch areas using approximately one pint of polyester resin in ambient temperatures below 70 degrees, approximately 7.5 cubic centimeters is recommended whereas for temperatures above 85 degrees, only approximately 5 cubic centimeters is recommended. Other activating mechanisms can be used in lieu of a catalyst, such as the application of heat to the resin, among others.

The aggregate can include sand, gravel, alone or in combination, among other well-known aggregates. The choice of aggregate depends, at least in part, on the application. For example, for applications using the surface repair composite to repair deep potholes (e.g., approximately 12 inches deep) or spalls may use a dry pea gravel in addition to sand to form the aggregate. The use of pea gravel assists in the filling of voids. As another application-specific example, non-slip topcoat and sealer applications using the surface repair composite may include broadcasted sand to provide a non-slip surface.

The fiber, as indicated above, can be chopped strand fiberglass, preferably of approximately quarter-inch in length, fiber mesh, among other fibrous materials. Table 2 below provides a specification for constituents and percentage of total composition of an example chopped strand fiber that can be used in the preferred embodiments of the invention. An exemplary manufacturer includes FIBERTEX™.

TABLE 2

| | |
|---|---|
| SiO₂ | 54.1 ± 0.5% |
| Al₂O₂ | 14.6 ± 0.4% |
| CaO | 24 ± 0.5% |
| MgO | <0.6% |
| B₂O₃ | 8.4 ± 0.5% |
| R₂O(K₂O < 0.5) | <0.8% |
| FeO₃ | <0.5% |

Other fiberglass types and compositions made by the same or other manufacturers can be used. For example, “hair-like” strands can be used, such as fiber products made by SI® Concrete Systems.

Referring back to FIG. 1, step 104 includes mixing the resin, the catalyst, the aggregate, and the fiber. The mixing can occur in various combinations and/or sequences. The sand-to-fiber composition is generally driven by economic considerations and the desired performance characteristics, as well as the type of fiber used, which may vary depending on the application. For example, the ratio of sand to fiber mesh used for the aggregate-fiber composition can be approximately 80% sand to 20% fiber mesh, whereas for chopped strand fiber, the ratio may be approximately 30% chopped strand (to 70% sand).

With regards to the aggregate-fiber composition in relation to the resin-catalyst mix, one rule of thumb that can be generally followed is to use three times the aggregate-fiber composition for the resin-catalyst mix (e.g., 48 ounces dry measure of an 80/20 sand fiber composition to 16 ounces of resin-catalyst mixture). In one implementation, approximately 12-15 square feet of area can be suitably covered by the entire mixture that corresponds to one gallon of the resin-catalyst mix (in the exemplary ratios described above) and 30# grit dry sand-fiber mesh composition in the exemplary ratios described above.

In some embodiments, the catalyst is added to the resin to form a gel-like composition, and the aggregate and fiber can be added to the gel-like composition and agitated (e.g., using an auger or similar device) to form a slurry. The aggregate is preferably pre-mixed with the fiber, but in other embodiments can be supplied separately from the aggregate and added to the resin-catalyst mixture contemporaneously with the fiber (e.g., before or after adding the aggregate, or at the same time). The end product from this example method is a surface repair composite with a consistency similar to fresh mortar. The surface repair composite can be applied to the repair surface using a hand trowel or other tools or application methodologies.

FIG. 2 is a flow diagram that illustrates an embodiment of one example method for using a surface repair composite. FIGS. 3A-3H are schematic diagrams that illustrate the method described in the flow diagram of FIG. 2. Referring to FIG. 2, step 202 includes preparing a repair surface. FIG. 3A is a schematic diagram that illustrates step 202, and shows a surface 302 such as concrete that has a surface irregularity, for example a pothole. The area of the surface 302 that is in need of repair is herein referred to as a repair surface 304. A person is shown here using a broom 306 to sweep away loose dirt and gravel. Preferably, the repair surface 304 is prepared by removing any vegetation, loose dirt, or gravel from the repair surface (e.g., the pothole). Additionally, the repair surface 304 is preferably cleaned and otherwise made substantially free of dirt, oil, grease, and/or moisture.

Step 204 (FIG. 2) includes taping around the repair surface. FIG. 3B is a schematic diagram that illustrates the person applying tape 306 around the perimeter of the repair surface 304. The tape 306 assists in providing a professional appearance to the final surface (i.e., post-repair). Additionally, applying the surface repair composite to the area within the tape boundary as well as on the tape, although not necessary, improves the strength of the repair as it encompasses surfaces surrounding the repair surface 304.

Step 206 (FIG. 2) includes mixing a catalyst with a resin. As illustrated in FIG. 3C, the person adds the catalyst 314 contained in container 315 to the resin 308 contained in container 312. The amount used can be minimal, depending on the surface area to be prepared, and thus a small deposit container can be used. Mixing may include agitating, for example by stirring. The proportions used for each constituent can be as described above.

Step 208 (FIG. 2) includes applying the resin-catalyst mix from step 206 to the repair surface. FIG. 3D illustrates how the person applies the resin-catalyst mix 317 (comprised of the resin 308 mixed with the catalyst 314) to the repair surface 304 by using a brush 310 or other tool (e.g., a roller) or method of application. Preferably, the resin-catalyst mix 317 is applied in an amount sufficient to cause the repair surface 304 to become “tacky” contemporaneously with the time of applying the surface repair composite. The application of the resin-catalyst mix 317 helps to ensure voids are filled, and thus somewhat functions as a primer.

Step 210 (FIG. 2) includes mixing a fiber and an aggregate with the composition comprising the catalyst and the resin (e.g., the resin-catalyst mix 317) to form a surface repair composite. Exemplary composition ratios are described above. FIGS. 3E-3F provide an illustration for step 210. As shown in FIG. 3E, the person can add the aggregate and fiber composite mix 316 from container 319 to the container 312, the container 312 containing the composition comprising the resin 308 and the catalyst 314. In other embodiments, the fiber and the aggregate can be packaged separately, and thus added contemporaneously (e.g., at the same time and/or the fiber added before the aggregate and/or the aggregate added before the fiber) to the composition 308 and 314. As indicated above, the steps may even be reversed, wherein the fiber and the aggregate are in a container, and a catalyst and a resin are added, in sequence or at the same time. Other variations may be employed. In FIG. 3F, the person is shown agitating the mix of resin 308, catalyst 314, and aggregate-fiber composite 316 with an auger device 318 to form a surface repair composite 320. Preferably, the mix (used to form the surface repair composite 320) is agitated until a slurry-like consistency is created, somewhat similar to fresh mortar.

Step 212 (FIG. 2) includes applying the surface repair composite to the repair surface. In FIG. 3G, the person is shown applying the surface repair composite 320 to the repair surface 304 using a hand trowel 322, although other tools and/or methods may be employed to apply the surface repair composite 320. Curing of the surface repair composite 320 can be less than two hours.

In FIG. 3H, the repaired surface 324 comprises the surface repair composite 320 (FIG. 3G) bonded to previously separated (i.e., separated by a gap created by the pothole) concrete surfaces. The preferred embodiments enable the repaired surface 324 to have greater strength than the concrete surface when intact, providing a tensile elongation factor of over 40%. Such tensile elongation factors enable the surface repair composite 320 to be used in applications where surface deflections upon loading are more prevalent and/or prominent, such as parking decks, bridges, etc.

Additionally, because the surface repair composite 320 (FIG. 3G) is chemical-based, it is more resistant to deterioration due to water evaporation.

In some embodiments, additional material may be added, such as pigmentation material to provide a better match in surface color.

Further, although shown with user interaction, one or more of the steps illustrated in FIGS. 2 and 3A-3G may be performed using mechanized equipment that removes user interaction in whole or in part, as would be understood by one having ordinary skill in the art.

Also, many variations of providing the various constituents of surface repair composites are possible. For example, kits can be provided wherein the fiber and aggregate are packaged in a first container (e.g., a plastic bag), a resin is packaged in a second container, and the catalyst is packaged in a third container. The first through third containers can all be part of one kit. As another example, only a resin-catalyst kit may be provided, such that a person may need to separately purchase the aggregate, or an aggregate-fiber composite mix.

It should be emphasized that the above-described embodiments are merely possible examples of implementations. Many variations and modifications may be made to the above-described embodiments. All such modifications and variations are intended to be included herein within the scope of this disclosure and protected by the following claims.

1. A surface repair composite, comprising:
a surface patch for bonding to concrete and asphalt surfaces, said patch including:
a resin;
a catalyst;
an aggregate; and
a fiber mixed with the resin, the catalyst, and the aggregate.

2. The surface repair composite of claim 1, wherein the resin includes at least one of an epoxy material, a polyester material, and a vinyl ester material.

3. The surface repair composite of claim 1, wherein the aggregate includes at least one of sand, pea gravel, black slag, and gravel.

4. The surface repair composite of claim 1, wherein the catalyst includes at least one of methyl ethyl ketone peroxide and benzoyl peroxide.

5. The surface repair composite of claim 1, wherein the fiber includes at least one of chopped strand fiberglass and fiberglass mesh.

6. The surface repair composite of claim 1, further including pigmentation material.

7. A method of making a surface repair composite, comprising:
providing a resin, a catalyst, an aggregate, and a fiber; and
mixing the resin, the catalyst, the aggregate, and the fiber, wherein a surface patch bondable to asphalt and concrete surfaces is formed.

8. The method of claim 7, wherein the mixing includes mixing the resin with the catalyst to form a first composition, and mixing the aggregate and the fiber with the first composition.

9. The method of claim 7, wherein the mixing includes mixing the fiber with the aggregate to form a second composite, and mixing the second composite with a mixture of the resin and the catalyst.

10. The method of claim 7, wherein the resin includes at least one of an epoxy material, a polyester material, and a vinyl ester material.

11. The method of claim 7, wherein the aggregate includes at least one of sand, pea gravel, black slag, and gravel.

12. The method of claim 7, wherein the catalyst includes an organic peroxide.

13. The method of claim 7, wherein the fiber includes at least one of chopped strand fiberglass and fiberglass mesh.

14. The method of claim 7, wherein the mixing includes agitating.

15. The method of claim 7, wherein mixing further includes mixing pigmentation material.

16. A method of using a surface repair composite, comprising:
providing a surface repair composite compatible with asphalt and concrete surfaces, the surface repair composite including a resin, a catalyst, an aggregate, and a fiber; and
applying the surface repair composite to a surface.

17. The method of claim 16, further including providing the resin.

18. The method of claim 17, further including providing the catalyst.

19. The method of claim 18, further including mixing the resin with the catalyst, wherein the mixing includes agitating.

20. The method of claim 19, further including providing the aggregate and the fiber, and further including mixing the aggregate with the fiber.

21. The method of claim 20, further including mixing the aggregate and the fiber with the resin and the catalyst, wherein the mixing includes agitating.

22. The method of claim 19, further including providing the aggregate and the fiber already mixed.

23. The method of claim 22, further including mixing the pre-mixed aggregate and fiber with the resin and the catalyst, wherein the mixing includes agitating.

24. The method of claim 16, wherein the resin includes at least one of an epoxy material, a polyester material, and a vinyl ester material.

25. The method of claim 16, wherein the aggregate includes at least one of sand, pea gravel, black slag, and gravel.

26. The method of claim 16, wherein the catalyst includes at least one of methyl ethyl ketone peroxide and benzoyl peroxide.

27. The method of claim 16, wherein the fiber includes at least one of fiberglass strands and fiberglass mesh.

28. The method of claim 16, wherein the applying includes applying to a concrete surface.

29. The method of claim 16, wherein the applying includes applying to an asphalt surface.

30. The method of claim 16, wherein the applying includes applying to a wood surface.

31. The method of claim 16, wherein the applying includes applying to a metal surface.

32. The method of claim 16, further including cleaning the surface, priming the surface with a primer composition comprising the resin and the catalyst, and applying tape approximately around the surface before applying.

33. The method of claim 16, further including adding pigmentation material.

34. A surface repair kit, comprising:
a container that includes an aggregate and a fiberglass product.

35. The kit of claim 34, further including a container that includes a resin.

36. The kit of claim 35, wherein the resin includes at least one of an epoxy material, a polyester material, and a vinyl ester material.

37. The kit of claim 34, further including a container that includes a catalyst.

38. The kit of claim 37, wherein the catalyst includes an organic peroxide.

39. The kit of claim 34, wherein the fiberglass product includes at least one of fiberglass strands and fiberglass mesh.

40. The kit of claim 34, wherein the aggregate includes at least one of sand and gravel.
